(19) United States
(12) Patent Application Publication
(10) Pub. No.: US 2013/0321713 A1
(43) Pub. Date: Dec. 5, 2013

(54) DEVICE INTERACTION BASED ON MEDIA CONTENT

(71) Applicant: Damian A. SCAVO, Firenze (IT)

(72) Inventor: Damian A. SCAVO, Firenze (IT)

(73) Assignee: AXWAVE INC., Boston, MA (US)

(21) Appl. No.: 13/843,081

(22) Filed: Mar. 15, 2013

Related U.S. Application Data
(60) Provisional application No. 61/653,728, filed on May 31, 2012.

(51) Int. Cl. H04N 5/60

(52) U.S. Cl. CPC H04N 5/60
USPC 348/738

(57) ABSTRACT

Device interaction based on media content is described, including receiving a portion of media data; generating metadata associated with the media data; identifying another metadata based on the metadata; identifying content information associated with the another metadata; and issuing a command based on the content information.

### TECHNICAL FIELD

The subject matter discussed herein relates generally to data processing and, more particularly, to device interaction based on media content.

### BACKGROUND

Some people may want to increase or decrease the sound volume when a specific content or type of content is heard from a radio or seen on a television (TV). For example, a user may be interested in turning up the volume when an emergency message is broadcasted on a radio or TV or turning down or muting the volume when a violent scene is played on the TV.

Some people may want to skip a radio commercial or TV commercial when it is played. Some parents may not want their children to listen to or watch some content or types of content.

A solution is needed.

### BRIEF DESCRIPTION OF THE DRAWINGS

FIG. 1 shows an example environment where media data are processed and used in applications.

FIG. 2 shows an example process suitable for implementing some example implementations.

FIG. 3A illustrates an example audio file.

FIG. 3B illustrates the example audio file of FIG. 3A with an added audio track.

FIG. 3C illustrates a matrix generated based on an example audio file.

FIGS. 4A-C show examples of new track generation.

FIGS. 5A-G show example processing of an audio file to generate one or more matrices.

FIG. 6 shows an example application using electronic media signature.

FIG. 7 shows an example client process according to some example implementations.

FIG. 8 shows an example service provider process according to some example implementations.

FIGS. 9A-D show some example implementations of device interaction based on media content.

FIG. 10 shows an example computing environment with an example computing device suitable for implementing at least one example implementation.

### DETAILED DESCRIPTION

The subject matter described herein is taught by way of example implementations. Various details have been omitted for the sake of clarity and to avoid obscuring the subject matter. Examples shown below are directed to structures and functions for implementing device interaction based on media content.

Overview

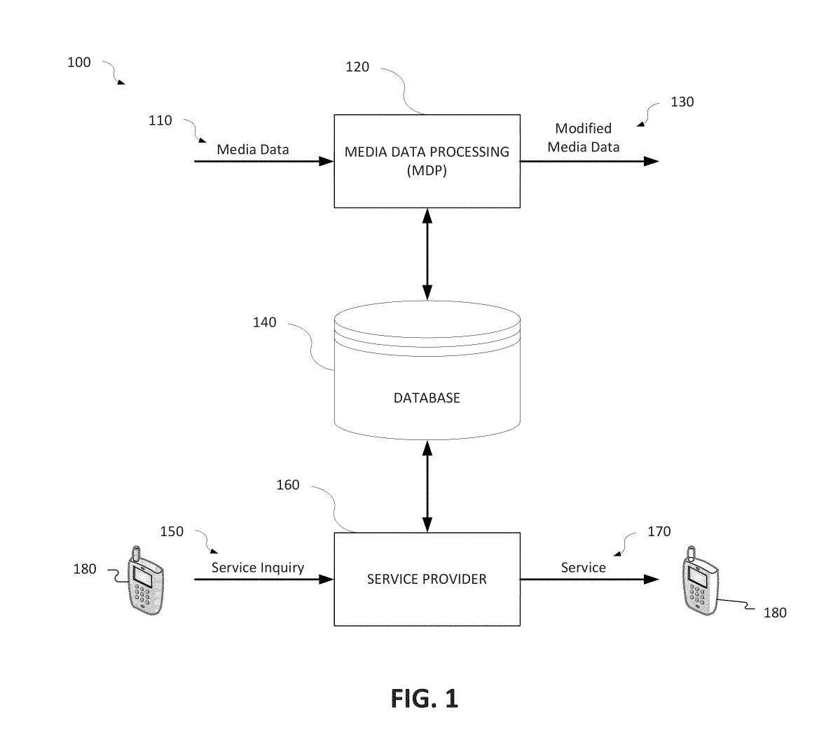

FIG. 1 shows an example environment where media data may be processed and used in one or more applications. Environment 100 shows that media data 110 may be input to media data processing (MDP) 120 for processing. For example, media data 110 may be uploaded, streamed, or fed live (e.g., while being broadcasted on a TV channel) to MDP 120. MDP 120 may interact with database 140 for storage needs (e.g., storing and/or retrieving temporary, intermediate, and/or post-process data). MDP 120 may provide modified media data 130 as output.

For example, MDP 120 may process media data 110, and store or caused to be stored one or more forms of media data 110 (e.g., modified media data 130) in databases 140 for use in one or more applications provided by service provider 160 (e.g., Media Identifying Engine). Service provider 160 may receive service inquiry 150 and provide service 170 using data (e.g., processed or modified media data) stored and/or retrieved in database 140. Service inquiry 150 may be sent by, for example, device 180. Service 170 may be provided to device 180.

Media data 110 can be audio data and/or video data, or any data that includes audio and/or video data, or the like. Media data 110 may be provided in any form. For example, media data may be in a digital form. For audio and/or video (AV) data, these may be analog data or digital data. Media data may be provided to (e.g., streaming) or uploaded to MDP 120, retrieved by or downloaded by MDP 120, or input to MDP 120 in another manner as would be understood by one skilled in the art. For example, media data 110 may be audio data uploaded to MDP 120.

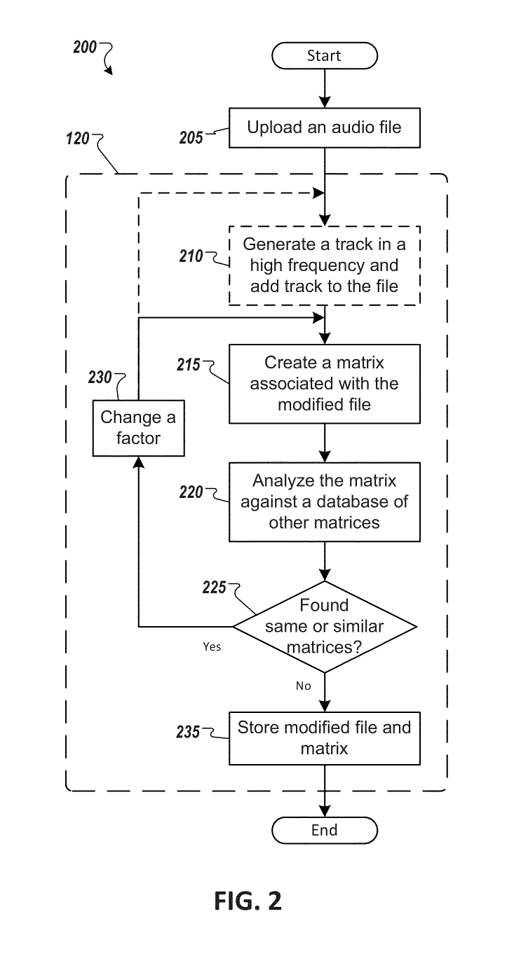

MDP 120 processes media data 110 to enable identifying the media data using a portion or segment of the media data (e.g., a few seconds of a song). An example process is described below in FIG. 2. In some example implementations, media data may be processed or modified. The processed or modified media data 130 may be provided (e.g., to the potential customer), stored in database 140, or both. Media data 110 may be stored in database 140.

The media data 110 and/or modified media data 130 may be associated with other information and/or content for providing various services. For example, media data 110 may be a media file such as a song. The media data 110 and/or modified media data 130 may be associated with the information relating to the song (e.g., singer, writer, composer, genre, release time, where the song can be purchased or downloaded, etc.).

When a potential purchaser hears the song being played, streamed, or broadcasted, the potential purchaser may record (e.g., using a mobile device or a smartphone) a few seconds of the song and upload the recording (e.g., as servicer inquiry 150) to service provider 160. The potential purchaser may be provided information about the song and the purchase opportunity (e.g., a discount coupon) and location to purchase or download the song (e.g., as service 170).

Example Processes for Signing or Fingerprinting Media

FIG. 2 shows an example process suitable for implementing some example implementations. One example of inputting media data into MDP 120 may be by uploading a file (e.g., an audio file) at operation 205. In this example, the media data are audio data, which may be contained in an audio file. In another example, the media data can be any combination of audio data, video data, images, and other data.

An audio file may be monophonic (e.g., single audio channel), stereophonic (two independent audio channels), or in another multichannel format (e.g., 2.1, 3.1, 5.1, 7.1, etc.). In some example implementations, one channel of audio data may be processed. For example, a single channel monophonic audio file, one of the two channels stereophonic or multichannel audio file, or a combination of (e.g., averaging) two or more channels of the stereophonic or multichannel audio file. In other example implementations, two or more channels of audio data may be processed.

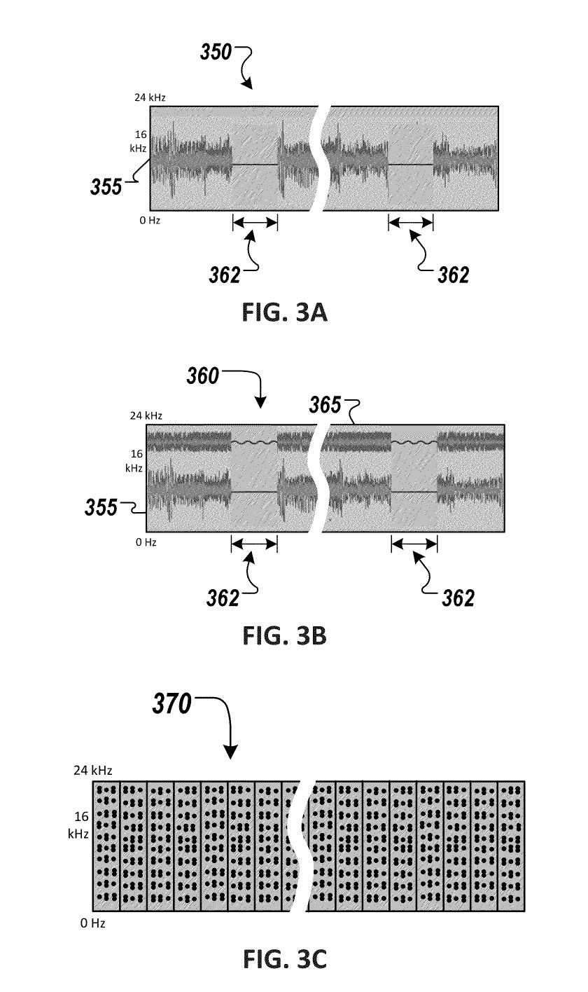

FIG. 3A illustrates an audio file 350 that may be uploaded at operation 205 of FIG. 2. Audio file 350 may contain analog audio data and/or digital audio data. In some implementations, analog audio data may be converted to digital audio data using any method known to one skilled in the art. Audio file 350 may be encoded in any format, compressed or uncompressed (e.g., WAV, mp3, AIFF, AU, PCM, WMA, M41, AAC, OGG, FLV, etc.). Audio file 350 includes data to provide an audio track 355 (e.g., a monophonic channel or combination of two or more channels of audio data). Audio track 355 may have one or more portions 362, such as silence periods, segments, or clips. Audio track 355 may be visually shown as, for example, an audio wave or spectrum.

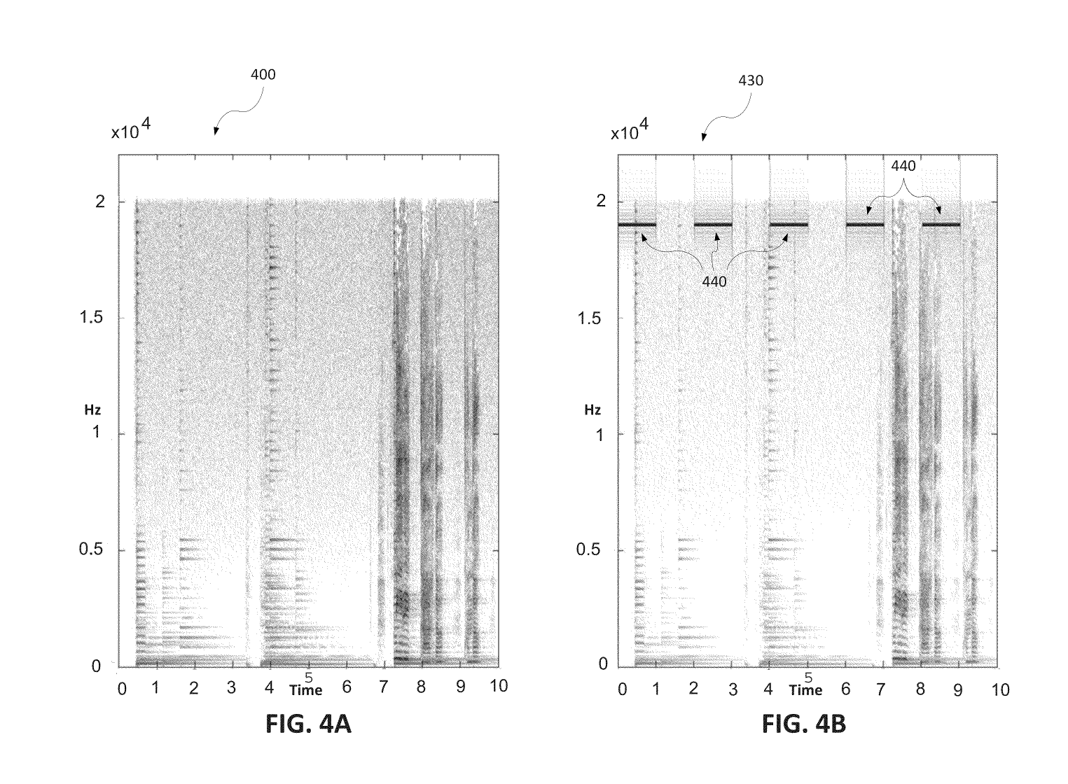

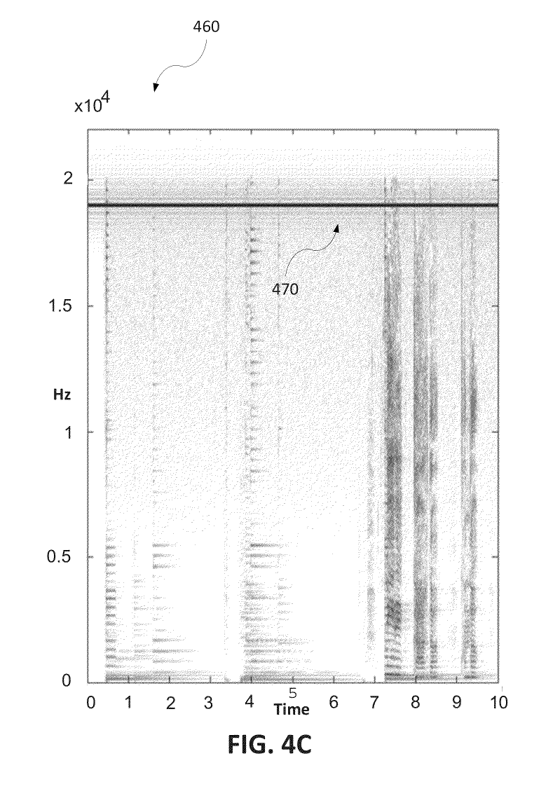

Referring to FIG. 2, at operation 210, an audio track in one or more frequencies (e.g., high frequencies) may be generated based on track 355. FIG. 3B illustrates the audio file of FIG. 3A with an added audio track. Modified audio file 360 includes audio track 355 and an added audio track 365. Audio track 365 adds audio data to audio file 360 to aid fingerprinting audio file 360 in some situations (e.g., where audio file 360 has a long silence period, frequent silence periods, and/or audio data concentrated in a small subset of the audio band or frequencies, etc.). This optional generation of a new track (e.g., a high frequency track) is described below in FIGS. 4A-C.

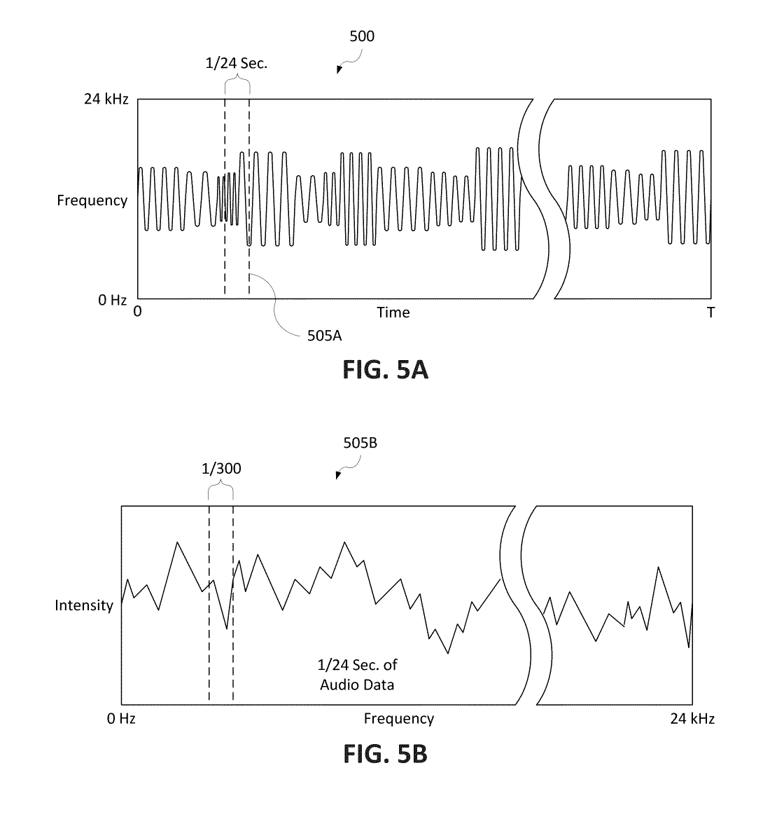

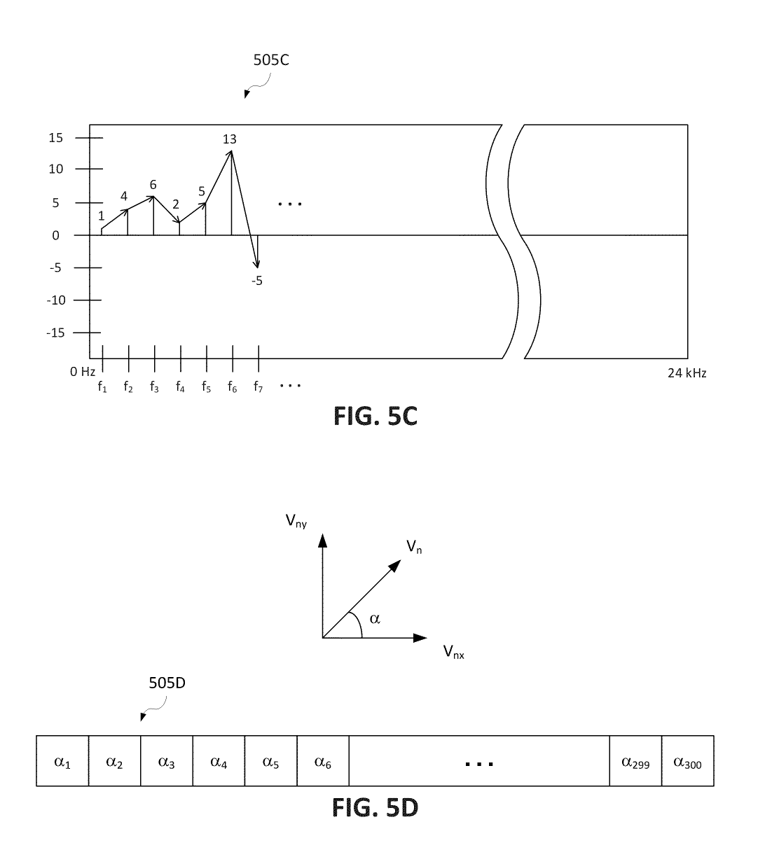

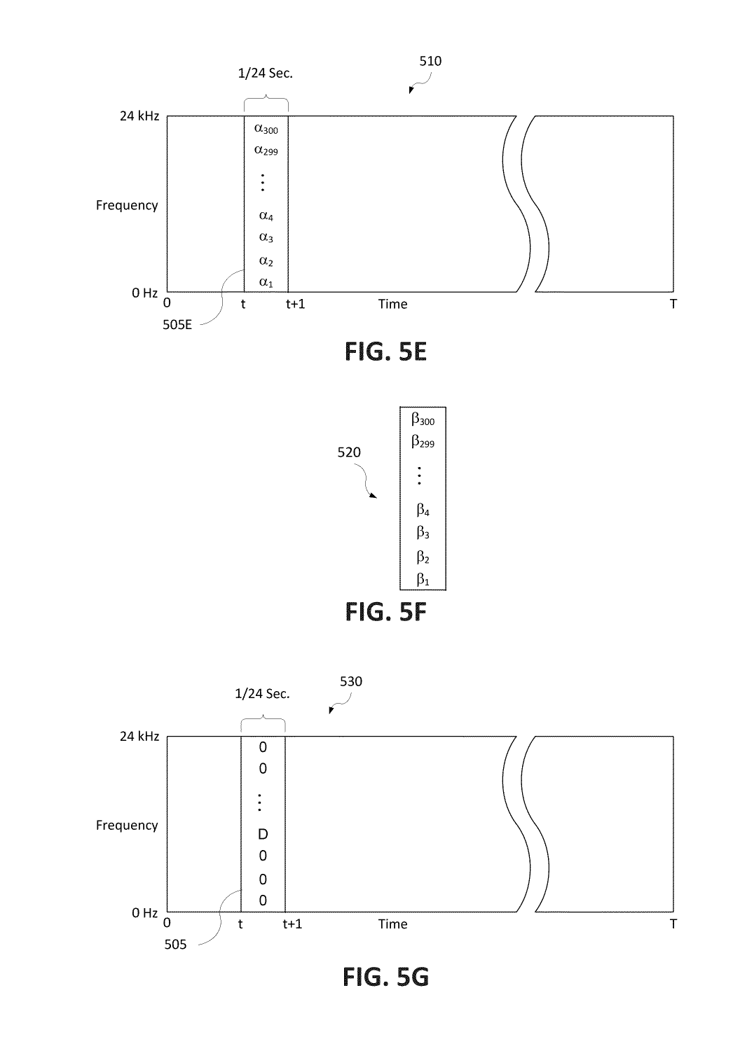

Referring to FIG. 2, at operation 215, a matrix associated with an audio file can be created. The audio file may be audio file 350 or the modified audio file 360. FIG. 3C illustrates an example matrix generated based on an audio file. Audio signals or data of the audio file (e.g., 350 or 360) are processed to generate matrix 370. FIG. 3C shows, as an example, one matrix 370. In some example implementations, there may be more than one matrix generated. For example, at least one matrix based on an audio file and one or more matrices based on the at least one matrix. These matrices (if more than one) are collectively referred to as matrix 370 for simplicity. The generation of matrix 370 is described below in FIGS. 5A-B.

Referring to FIG. 2, at operation 220, matrix 370 may be analyzed to determine whether there are the same and/or similar matrices stored in database 140. In some example implementations, similarity between two matrices may be derived by comparing like parts of the matrices based on one or more acceptance threshold values. For example, some or all counterpart or corresponding elements of the matrices are compared. If there are differences, and the differences are less than one or more threshold values, the elements are deemed similar. If the number of same and similar elements are within another threshold value, the two matrices may be considered to be the same or similar.

A matrix that is the same as or similar to another matrix implies that there is an audio file the same as or similar to audio file 350 or 360, the audio file used to generate matrix 370. If there is another matrix that is the same as or similar to matrix 370 at operation 225, a factor is changed at operation 230. The factor may be any factor used to create the additional track 365 as described in FIGS. 4A-C below and/or any factor used to create the matrix 370 as described in FIGS. 5A-B below. For example, one or more high frequencies may be changed to create a new track 365.

From operation 230, process 200 flows back to block 210 to create the audio track 365 and matrix 370. In implementations that do not include generation of an additional audio track 365, at 210, process 200 flows back to operation 215 to recreate the matrix 370. If a similar or same matrix as matrix 370 is not found, at operation 225, matrix 370 and/or the audio file 350 or 360 may be stored in one or more databases (e.g., database 140), at operation 235. An implementation may ensure that, at some time, operation 235 is reached from operation 225. For example, one or more threshold values may be increased or changed with the number of iterations (e.g., operation 225 loops back to operation 230) to guarantee that operation 235 is reached from operation 225 based on some threshold value.

An audio file may be associated with a unique identifier. Two or more audio files (e.g., audio files 350 and 360) can be used in different applications or the same applications. An audio file may be associated with an identity (e.g., an advertisement for “Yummi Beer”) or a type of content (e.g., a beer advertisement). The association is stored in database 140 at operation 235 for providing when a match with a matrix or media file is identified.

In some example implementations, an audio file (e.g., audio file 350) may be processed more than once to generate more than one corresponding matrix 370. For example, audio file 350 may be processed 10 times, some with additional tracks and some without additional tracks, to generate 10 corresponding matrices 370. Audio file 350 may be assigned 10 different identifiers to associate with the 10 corresponding matrices 370. The 10 “versions” of audio file 350/matrix 370 pairs may be used in one or more products, services, and/or applications. While an example of 10 iterations has been provided, the example implementation is not limited thereto and other values may be substituted therefor as would be understood in the art, without departing from the scope of the example implementations.

In some examples, process 200 may be implemented with different, fewer, or more operations. Process 200 may be implemented as computer executable instructions, which can be stored on a medium, loaded onto one or more processors of one or more computing devices, and executed as a computer-implemented method.

FIGS. 4A-C show examples of new track generation. FIG. 4A shows a spectrogram of audio data 400 before a new track is added. For example, audio data 400 may be audio track 355 shown in FIG. 3A. Audio data 400 may be any length (e.g., a fraction of second, a few seconds, a few minutes, many minutes, hours, etc.). For simplicity, only 10 seconds of audio data 400 is shown.

The vertical axis of audio data 400 shows frequencies in hertz (Hz) and the horizontal axis shows time in seconds. Sounds or audio data are shown as dark spots, the darker the spot, the higher the sound intensity. For example, at seconds 1 and 2, dark spots are shown between 0 Hz to 5 kilohertz (kHz), indicating that there are sounds at these frequencies. At time=4 and 7-9, dark spots are shown at frequencies 0 Hz to about 2 kHz, indicating that there are sounds at a wider range of frequencies. Sound intensity is higher at time>7.

FIG. 4B shows a spectrogram of audio data 430, which is audio data 400 of FIG. 4A with added audio 440 (e.g., additional track 365 of FIG. 3B). Audio data 440 are shown added in some time intervals (e.g., intervals between the second marks 0 and 1, between the second marks 2 and 3, etc.) and not in other time intervals (e.g., intervals between the second marks 1 and 2, between the second marks 3 and 4, etc.). Audio data 440 may be referred to as pulse data or non-continuous data.

Audio data 440 are shown added in alternate intervals in the same frequency (e.g., a frequency at or near 19.5 kHz). In some example implementations, audio data may be added in different frequencies. For example, an audio note at one frequency (Node 1) may be added in intervals between the second marks 0 and 1 and between the second marks 2 and 3, an audio note at another frequency (Node 2) may be added in another interval (e.g., the interval between the second marks 4 and 5), an audio note at a third frequency (Node 3) may be added in intervals between the second marks 5.5 and 6 and between the second marks 7 and 9, etc. Intervals where audio data are added and/or where no audio data is added may be in any length and/or of different lengths.

FIG. 4C shows a spectrogram of audio data 460, which is audio data 400 of FIG. 4A with added audio 470 (e.g., additional track 365 of FIG. 3B). Audio data 470 are shown added in all time intervals (e.g., continuous data). Audio data 470 are shown added in the same frequency (e.g., a frequency at or near 19.5 kHz).

In some example implementations, audio data 470 may be added in different frequencies. For example, an audio note at one frequency (Node 4) may be added in intervals between the second marks 0 and 3 and between the second marks 5 and 6, an audio note at another frequency (Node 5) may be added in another interval (e.g., the interval between seconds 3 and 5), an audio note at a third frequency (Node 6) may be added in intervals between the second marks 6 and 6.7 and between the second marks 7 and 9, an audio note at a fourth frequency (Node 7) may be added in intervals between the second marks 6.7 and 7 and between the second marks 9 and 10, etc. Intervals where audio data are added may be in any length and/or of different lengths.

Audio data including added audio data 440 and 470 may be in one or more frequencies of any audio range (e.g., between 0 Hz to about 24 kHz). In some example implementations, added audio data 440 and 470 may be in one or more frequencies above 16 kHz or other high frequencies (e.g., Note 1 at 20 kHz, Note 2 at 18.2 kHz, and Note 3 at 22 kHz).

High frequencies are frequencies about 10 kHz (kilohertz) to about 24 kHz. It is well known that some humans cannot hear sound above certain high frequencies (i.e., high frequency sound is inaudible or “silence” to these humans). For example, sound in 10 kHz and above may be inaudible to people at least 60 years old. Sound in 16 kHz and above may be inaudible to people at least 30 years old. Sound in 20 kHz and above may be inaudible to people at least 18 years old. The inaudible range of frequencies may be used to transmit data, audio, or sound not intended to be heard.

A range of high frequency sound may offer a few advantages. For example, high frequency audio data in an inaudible range may be used to provide services without interfering with listening pleasure. The range can be selected from high frequencies (e.g., from 10 kHz to 24 kHz) based on the implementations' target users (e.g., in products that target different market populations). For example, a product that targets only users having a more limited auditory range may use audio data about 10 kHz to about 24 kHz for services without interfering the their listening activities. For example, some users may not be able to hear audio or sound in this range, as explained above. To target users or consumers having a broader auditory range, the range may be selected from about 20 kHz to about 24 kHz, since many such users may hear sound near or around 16 kHz.

Further advantages may include that existing consumer devices (e.g., smart phones, radio players, TVs, etc.) are able to record and/or reproduce audio signals up to 24 kHz (i.e., no special equipment is required), and sound compression standards (e.g., MP3 sound format) and audio transmission systems are designed to handle data in frequencies up to 24 kHz.

In some examples, audio data 440 and 470 may be added in such a way that they are in harmony with audio data 400 (e.g., in harmony with original audio data). Audio data 440 and 470 may be one or more harmony notes based on musical majors, minors, shifting octaves, other methods, or any combination thereof. For example, audio data 440 and 470 may be one or more notes similar to some notes of audio data 400, and generated in a selected high frequency range, such as in octaves 9 and/or 10.

Another example of adding harmonic audio data may be to identify a note or frequency (e.g., a fundamental frequency) f₀ of an interval (e.g., the interval in which audio data is added), identify a frequency range for the added audio data, compute the notes or tones based on f₀ (e.g., f₀, 1.25*f₀, 1.5*f₀, 2*f₀, 4*f₀, 8*f₀, 16*f₀, etc.), and add one or more of these tones in the identified frequency range as additional audio data, pulse data or continuous data.

Referring to FIG. 3B, adding additional audio data (e.g., audio track 365) to original audio data (e.g., track 355) may be referred to as signing the original audio data (e.g., track 365 is used to sign track 355). Audio file 360 may be consider “signed,” because it contains a unique sound track (e.g., track 365) generated ad hoc for this file (e.g., generated based on track 355). After adding an audio track, audio file 360 may be provided to the submitter of audio file 350 (FIG. 3A, the submitter of the original audio file with the original audio track 355) and/or provided to others (e.g., users, subscribers, etc.). In some examples, audio file 360 may be stored (e.g., in database 140, FIG. 1) with a unique identifier, which can be used to identify and/or locate audio file 360.

In some example implementations, there may be more than one audio file generated for track 355. Each audio file may be generated with a track different from another generated track in another file.

FIGS. 5A-G show example processing of an audio file to generate one or more matrices. FIG. 5A shows an example audio file 500 (e.g., audio file 350 of FIG. 3A or 360 of FIG. 3B). Audio file 500 is visually represented with frequencies (e.g., 0 Hz to 24 kHz) on the y-axis and time on the x-axis.

In one or more operations, Fourier transform operations (e.g., discrete Fourier transform (DFT) and/or fast Fourier transform (FFT), etc.) may be used to reduce the amount of media data to process and/or filter out data (e.g., noise and/or data in certain frequencies, etc.). The Fourier transform, as appreciated by one skilled in the arts of signal processing, is an operation that expresses a mathematical function of time as a function of frequency or frequency spectrum. For instance, the transform of a musical chord made up of pure notes expressed as amplitude as a function of time is a mathematical representation of the amplitudes and phases of the individual notes that make it up. Each value of the function is usually expressed as a complex number (called complex amplitude) that can be interpreted as a magnitude and a phase component. The term “Fourier transform” refers to both the transform operation and to the complex-valued function it produces. One of ordinary skill in the art will appreciate that other mathematical transforms, for example, but not limited to, an S transform, a Stockwell transform, etc., may be used without departing from the scope of the present inventive concept.

Audio file 500 may be processed by processing slices of audio data. Each slide may be 1/M of a second, where M may be 1, 4, 24, up to 8000 (8 k), 11 k, 16 k, 22 k, 32.k 44.1 k, 48 k, 96 k, 176 k, 192 k, 352 k, or larger. In this example, M is 24. A slide of audio data (e.g., slide 505A) contains 1/24 second of audio data).

FIG. 5B shows slide 505A in detail as slide 505B. Slide 505B is shown rotated 90 degrees clockwise. The y-axis of slide 505B shows signal intensity (e.g., the loudness of audio). The x-axis shows frequencies (e.g., 0 Hz to 24 kHz). The audio data of slide 505B may be processed to produce numerical data shown in slide 505C in FIG. 5C using, for example, Fourier Transform operations. For example, slide 505B may be divided, (e.g., using Fourier transform) in N frames along the x-axis or frequency axis, where each frame is 1/N of the example frequency range of 0 Hz to 24 kHz. In some example implementations, the N frames may be overlapping frames (e.g., frame n2 overlaps some of frame n1, etc.).

FIG. 5C shows an expanded view of slide 505B. The y-axis of slide 505C shows signal intensity. The x-axis shows frequencies (e.g., 0 Hz to 24 kHz). Example intensity values of some frames (e.g., f1-f7) are shown. The intensity values of frames (f1 to f7 . . . )=(1, 4, 6, 2, 5, 13, −5 . . . ). In some example implementations, an angle is computed for each frame. For example, an angle (α) may be computed using two-dimensional vector Vn, where Vx is set to 1 and Vy is the difference between two consecutive frame values.

Here, V0=(Vx, Vy)=(1, 4−1)=(1, 3)

V1=(1, 6−4)=(1, 2)

V2=(1, 2−6)=(1, −2)

V3 to V299 are computed the same way.

Next, α₀ to α₂₉₉ are computed, where αₙ=arctan (Vny/Vnx) (e.g., α₁=arctangent (V1y/V1x).

FIG. 5D shows slide 505C has been reduced to slide 505D of alpha (e.g., angle) values. FIG. 5E shows slide 505D as slide 505E in the context of matrix 510. Slide 505E covers only 1/24 second of audio data. For a 30 second audio file, for example, matrix 510 includes 30×24, or 720 slides of 300 alpha values, making matrix 510 a 300-by-720 matrix. The matrix 510 can be considered as a fingerprint of audio file 350 or 360.

In some example implementations, one or more filtered matrices based on or associated with matrix 510 may be derived. For example, a filtered matrix may be created with the cross products of the α values of matrix 510 with one or more filter angles, β. FIG. 5F shows an example column 520 of one or more β values.

The β values may be any values selected according to implementation. For example, taking advantage of the fact that α×β (cross product of α and β) equal zero (0) if α and β are parallel angles, β may be selected or determined to be an angle that is parallel to many α angles in matrix 510 and/or other matrices. β may be changed (e.g., periodically or at any time). When a β value is selected or determined, it may be communicated to client processing application for use and other purposes.

In the example of column 520, β1 to β300 may be the same value selected, for example, to be parallel or near parallel to the most numbers of angles in matrix 510 and/or other matrices in database 140.

FIG. 5G shows a filtered matrix 530 with filtered values elements. For example, slide 505G shows filtered values that correspond to the α angles of slide 505E of matrix 510 (FIG. 5E). The filtered values of slide 505G are cross products of the α angles of slide 505E with the β values of column 520 (FIG. 5F).

The description of FIGS. 5A-G focuses on a single slide to illustrate how the corresponding slide in matrices 510 and 530 may be created. The process to create the slide in matrices 510 and 530 is applied to all the slides to create the entire matrices 510 and 530. In some example implementations, the process to create the matrices 510 and 530 may be different, such as with fewer, more, or different operations. One of ordinary skill in the art will appreciate that the above-described matrix methods of audio processing are merely exemplary and other methods may be used without departing from the scope of the present inventive concept.

Example Applications Using Signed or Fingerprinted Media

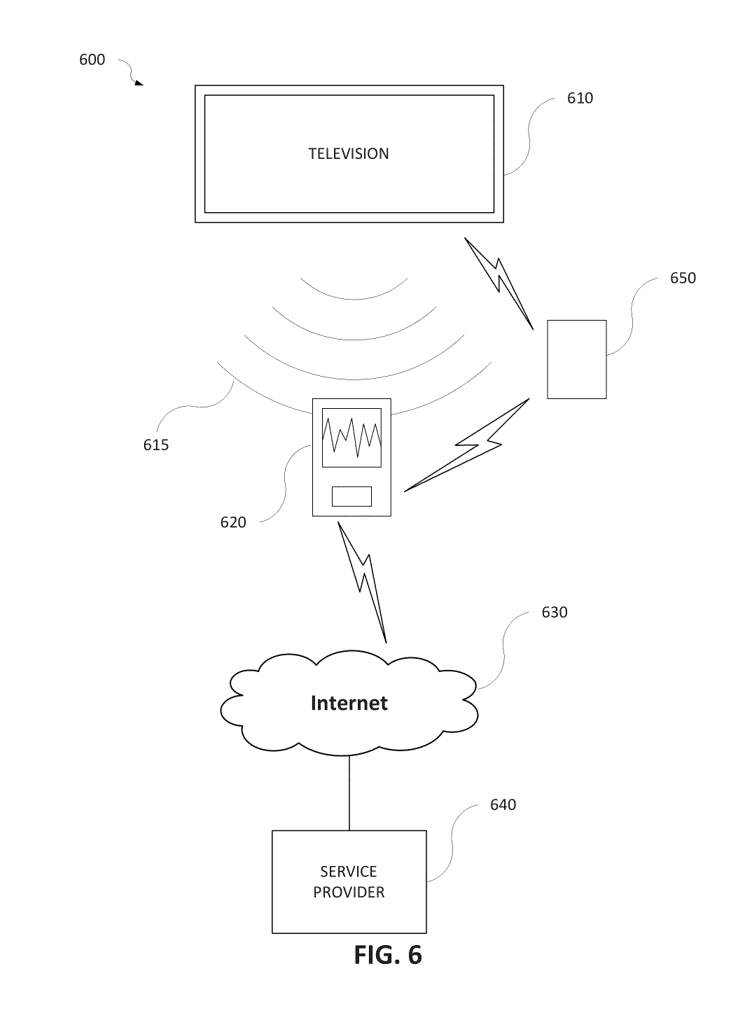

FIG. 6 shows an example application using electronic media signature. Example 600 includes a media source 610 (e.g., television or TV, radio, computer, etc.) that broadcasts, plays, or outputs audio data 615. Device 620 may capture or record a short segment of audio data 615 from a media source 610, for example, when media source 610 is playing an advertisement or commercial.

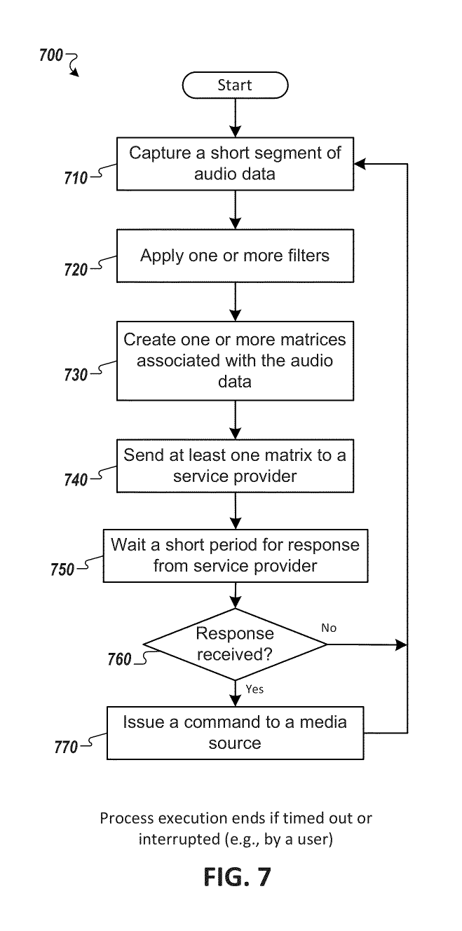

Media data 615 may be captured over the air (e.g., the sound waves travel in the air) or directly from media source 610 (e.g., transmitted via a wire, not shown, connecting the media source 610 and device 620). Device 620 may process the media data to generate one or more matrices (client matrices) as described in FIG. 7 below, and send one or more of the client matrices and/or captured media data to service provider 640 via, for example, one or more networks (e.g., internet 630). Device 620 may communicate with service provider 640 using one or more wireless (e.g., Bluetooth, Wi-Fi, etc.) and/or wired protocols.

Device 620 may repeat the captured media data 615, process the captured media data, and send the processed results to the service provider 640 until the repetition is stopped (e.g., by a user or timeout trigger). In some example implementations, device 620 may wait for a short period (e.g., a fraction of a second) before repeating the next capture-process-send cycle.

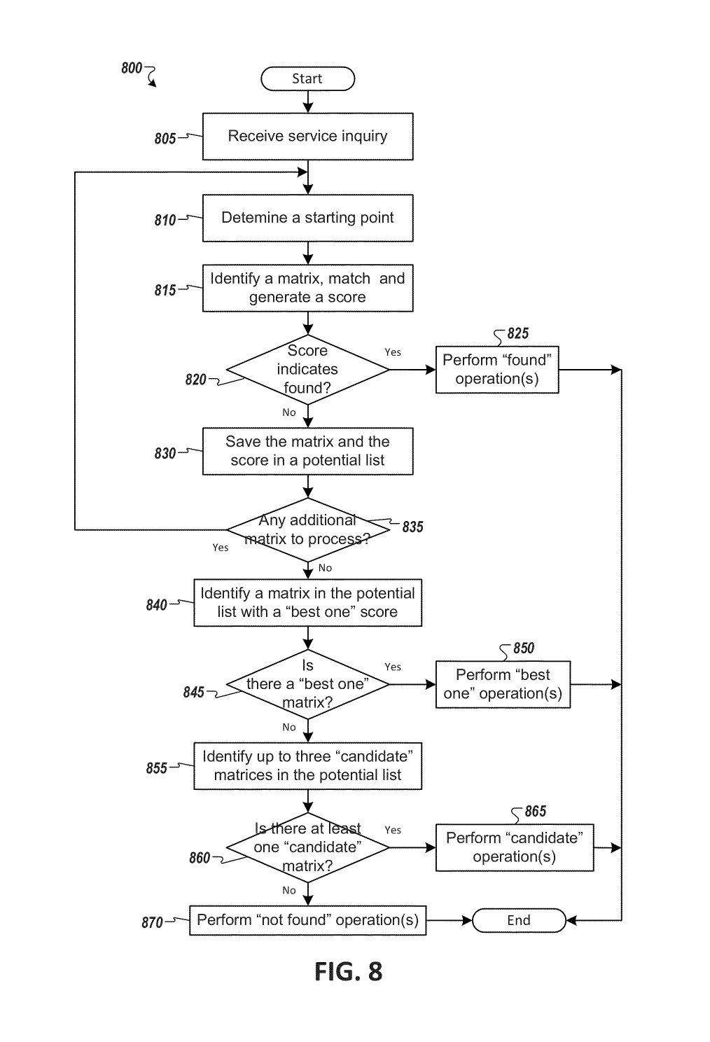

Service provider 640 uses the client matrices and/or captured media data to identify media data 615 as described in FIG. 8 below. When media data 615 is identified (e.g., as belonging to an advertisement), service provider 640 may provide the identity of media data 615 (e.g., an advertisement for “Yummi Beer”) or provide the type of content (e.g., a beer advertisement) to device 620 via internet 630. Device 620 may determine whether to perform an action based on the identity or type of media data 615.

For example, a command to switch to a different channel may be issued based on the identity that media data 615 belongs to an advertisement. Device 620 may issue the channel switching command to a device 650 to communicate with media source 610 to change the channel, increase the sound volume, decrease the sound volume, mute the audio output, power off, or perform another action. Device 620 may communicate with device 650 using any wireless (e.g., Bluetooth, Wi-Fi, etc.) or wired protocol implemented or supported on both devices. Device 650 may communicate with media source 610 using any wireless (e.g., infrared, Bluetooth, Wi-Fi, etc.) or wired protocol implemented or supported on both devices. Example 600 shows an example implementation of device interaction based on media content.

FIG. 7 shows an example client process according to some example implementations. When a person (Person P) wants to use device interaction based on media content while watching video or listening to audio (e.g., being played, streamed, broadcasted, or the like) Person P may take out his or her smart phone (e.g., device 620, FIG. 6 or device 180, FIG. 1) and press a record button associated with an application (App A). App A starts process 700 by, for example, recording or capturing a short segment (e.g., a second or a few seconds) of media data (Segment S) at operation 710. Segment S is media data (e.g., audio data). App A may be installed for at least the purposes of identifying the media data and/or associated services using a service provider.

In some example implementations, App A may apply one or more filters or processes to enhance Segment S, to isolate portions of Segment S (e.g., isolate certain frequency ranges), and/or filter or clean out noises captured with Segment S, at operation 720. For example, recording Segment S at a restaurant may also record the background noises at the restaurant. Well-known, less well-known, and/or new noise reduction/isolation filters and/or processes may be used, such as signal whitening filter, independent component analyzer (ICA) process, Fourier transform, and/or others.

App A then processes the Segment S (e.g., a filtered and/or enhanced Segment S) to create one or more matrices associated with the audio data of Segment S at operation 730. For example, App A may use the same or similar process as process 200 described in FIG. 2 above (with the operations at operation 210 of process 200 omitted).

App A (e.g., process 700) may produce matrices that are not the same as matrices produced by process 200 due to noise and size. Media data with noise are not the same as noise-free media data. Therefore, matrices produced by App A using media data captured with noise (e.g., captured over the air) are not the same as those produced by process 200 using noise-free media data (e.g., uploaded media data).

App A (e.g., process 700, FIG. 7) processes media data (e.g., Segment S) that may be a subset (e.g., shorter in duration) of the media data processed by process 200. For example, process 200 may process the entire 30 seconds of an advertisement, and App A may process only a few seconds or even less (e.g., Segment S) of the advertisement. For example, Segment S may be a recording of about three seconds of the advertisement. With the ratio of 10 to 1, matrices produced with Segment S are about 1/10 the size of the matrices produced with the advertisement.

With an example sampling rate of 24 times per second, multiplied by 30 seconds, and a division of the audio frequency range (e.g., 0 Hz to 24 kHz) into 300 sub-ranges, process 200 produces a 300-by-720 matrix (Big M) of α values (described above). App A produces a 300-by-72 matrix (Small M) of α values. If Segment S is the first three seconds of the advertisement, α values in Small M would be equal to the α values of the first 72 columns of a Big M (if noise in Segment S is eliminated). If Segment S is seconds 9, 10, and 11 of the advertisement, α values in Small M would be equal to the α values of columns 193 to 264 of a Big M (if noise in Segment S is eliminated). If Segment S is the last three seconds of the advertisement, α values in Small M would be equal to the α values of the last 72 columns of a Big M (if noise in Segment S is eliminated). The number of sub-ranges (e.g., 300) is only an example. Other numbers of sub-ranges may be used in processes 200 and 700.

App A (e.g., process 700) may produce a filtered matrix (Small F) corresponding to Small M using the same β value received from the service provider that produces a filtered matrix (Big F) corresponding to Big M. Sizes and ratio of Small F and Big F are the same as those of Small M and Big M. Small F may be produced using the same or a similar process as described in FIG. 2.

App A sends the Small F, Small M, and/or Segment S (pre-filtered or post-filtered) to service provider 640 at operation 740. At operation 750, App A waits a short period (e.g., a fraction of a second) for a response from Service provider 640. Service provider 640 processes the data sent by App A as described in FIG. 8 below. Service provider 640 may return or respond to App A if service provider 640 identifies the advertisement of which Segment S is a portion. At operation 760, App A determines if a response has been received. If yes, at operation 770, App A issues a command to a media source (e.g., media source 610) to, for example, change a channel to another channel, change the sound volume, power off, etc. Process 700 then flows back to operation 710. If the determination at operation 760 is no, process 700 flows back to operation 710. A user may interrupt or end process 700 at any point. In some example implementations, process 700 may be implemented to end after a time out period (e.g., a period in seconds, minutes, or hours).

A command may be any command or series of two or more commands programmable by device 620. In some example implementations, device 620 may include a list of content and/or types of contents with associated commands. For example, the command associated with content identified as advertisement may be to advance or change to the next channel above or below the current channel. In some example implementations, device 620 may include a list of channels (e.g., “favorite” channels) for channel selection or advancement in response to a change channel command. An example of a series of commands may be advancing to the next channel in the same direction (up or down) every X seconds until Y seconds later, after which, return to the current channel.

In some examples, process 700 may be implemented with different, fewer, or more operation. For example, the operations of one or more of operations 720 and 730 may be performed by service provider 640 instead of or in addition to the operations performed by App A. For example, App A may send the pre-filtered Segment S to service provider 640 after operation 710 or send the post-filtered Segment S to service provider 640 after operation 720.

Process 700 may be implemented as computer executable instructions, which can be stored on a medium, loaded onto one or more processors of one or more computing devices, and executed as a computer-implemented method.

FIG. 8 shows an example service provider process according to some example implementations. Process 800 starts when a service provider (e.g., service provider 640) receives a service inquiry at operation 805. For example, service provider 640 receives the Small F, Small M, and/or Segment S from a device that captured the Segment S media data (client device).

In an example implementation, Small F is received by Service provider 640. At operation 810, service provider 640 determines a starting point based on the received information (e.g., Small F). Any point may be a starting point, such as starting from the oldest data (e.g., oldest Big F). However, some starting points may lead to faster identification of the Big F that corresponds with the Small F. For example, in an application where live content is being identified, service provider 640 may start with a Big F out of a pool of newly generated Big Fs from live content (e.g., the same live broadcast may be captured as Segment S by device 620 and fed to MDP 120, FIG. 1, associated with or part of service provider 640).

One example of determining a starting point may be using data indexing techniques. For example, to identify the corresponding Big F faster, all the Big Fs may be indexed using extreme (e.g., the maximum and minimum) values of the sampled data. There are 720 maximum values and 720 minimum values in a 300-by-720 Big F matrix. These 720 pairs of extreme values are used to index the Big F. When the Small F is received, extreme values of the Small F are calculated to identify a Big F using the index to determine the starting point.

Further examples of determining a starting point may use one or more characteristics or factors relating to, for example, the user who recorded Segment S, the time, the location, etc. For example, the location of the user may indicate that the user is in California. With that information, all media files (e.g., the associated matrices) that are not associated with California may be eliminated as starting points. If Segment S is received from a time zone that indicates a time past midnight at that time zone, most media files associated with most children's products and/or services may be eliminated as starting points. Two or more factors or data points may further improve the starting point determination.

When a starting point is determined or identified, a matrix (e.g., a Big F) is identified or determined and a score is generated at operation 815. In some example implementations, identifying a starting point also identifies a matrix.

The score may be generated based on the Small F and Big F. Using the example of 1/10 ratio of Small F/Big F, the Small F may need to align with the correct portion of Big F to determine the score. In one example, Big F may be divided into portions, each at least the size of Small F. The portions may be overlapping. In the example of a three-second Small F, each portion is at least three seconds worth of data. One example may be having six-second portions overlapping by three seconds (e.g., portion 1 is seconds 1-6, portion 2 is seconds 4-9, portion 3 is seconds 7-12, etc.).

With an example sampling rate of 24 times per second, Small F would cover 72 samplings and each portion of Big F would cover 144 samplings. One process to determine a score may be as follows.

For p = 1 to 9; // nine overlapping 6-second portions

P_score[p] = 0; // portion scores
For i = 0 to 72; // 73 overlapping 72 samples per

portion

Score[i] = 0;
For s = 1 to 72;

compare sample score = Compare Small F[s] with

Big F[(p*72)+i+s];

Score[i] = Score[i] + compare sample score;

End For s

End For i
P_score[p] = the minimum of Score[i], for i = 0 to

72;

End For p
Final score = the minimum of P_score[p], for p = 1 to

9;

Comparing a sample of Small F (e.g., 300 filtered values that mainly equal to zero) to a sample of a portion (e.g., another 300 filtered values that mainly equal to zero) may be summing up the difference between 300 pairs of corresponding filtered values. For example, the “Compare” operation may be implemented as the following loop.

For j = 1 to 300;

compare sample score = compare sample score +

(Small F[s][j] − Big F[(p*72)+i+s][j]);

End For j

The final score (e.g., the score obtained from processing the Small F with one Big F) is used to compare to one or more threshold values to determine whether a corresponding Big F has been found. Finding the corresponding Big F would lead to finding the advertisement. In some example implementations, one or more threshold levels may be implemented. For example, there may be threshold values of X and Y for the levels of “found,” “best one,” and “not found.” A final score between 0 and X may be considered as “found.” A final score between X+1 and Y may be considered as “best one.” A final score greater than Y may be considered as “not found.”

At operation 820, if the final score indicates “found,” one or more “found” operations are performed at operation 825 (e.g., provide to device 620, in a response, the identity or type of content associated with the found Big F). “Found” operations, “best one” operations, and “not found” operations are based on the identity or type of content associated with the media file (e.g., the advertisement) associated with the “found” Big F.

At operation 820, if the final score does not indicate “found,” save the final score and the Big F matrix associated with the final score in, for example, a potential list, at operation 830. At operation 835, if the saved Big F is not the last Big F process (e.g., there is at least one Big F not processed yet), process 800 loops back to operation 810. Otherwise, process 800 flows to operation 840 to identify a Big F with a final score in the “best one” level.

At operation 845, if there is a “best one” score (a lowest “best one” score may be selected if there is more than one), process 800 flows to operation 850 to perform the “best one” operations. For example, the “best one” operation may be the same or similar to the “found” operations (e.g., provide to device 620, in a response, the identity or type of content associated with the found Big F). In some example implementations, the “best one” operations may be altered or different from the “found” operation.

At operation 845, if there is no “best one” score, process 800 flows to operation 855 to perform the “not found” operations. For example, a status or message indicating “cannot locate a match” may be provided to device 620. Instructions may be provided to record a better Segment S (e.g., move device 620 to a different position).

In some examples, process 800 may be implemented with different, fewer, or more operation. Process 800 may be implemented as computer executable instructions, which can be stored on a medium, loaded onto one or more processors of one or more computing devices, and executed as a computer-implemented method.

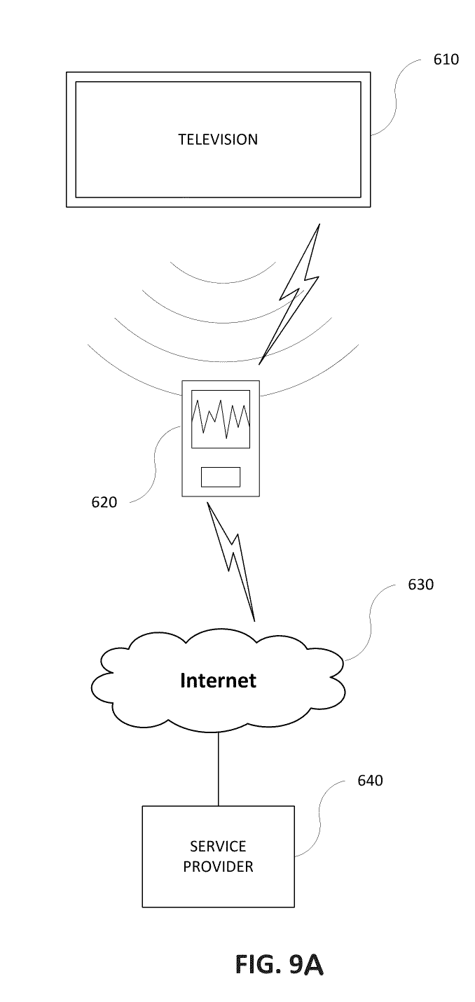

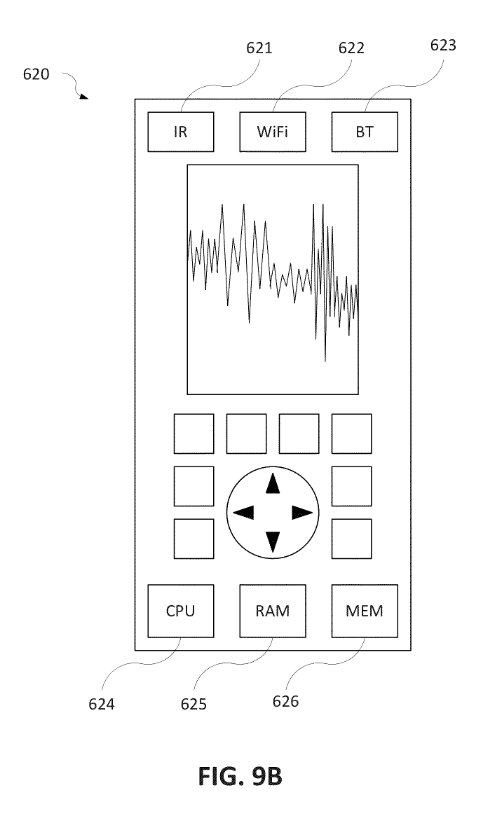

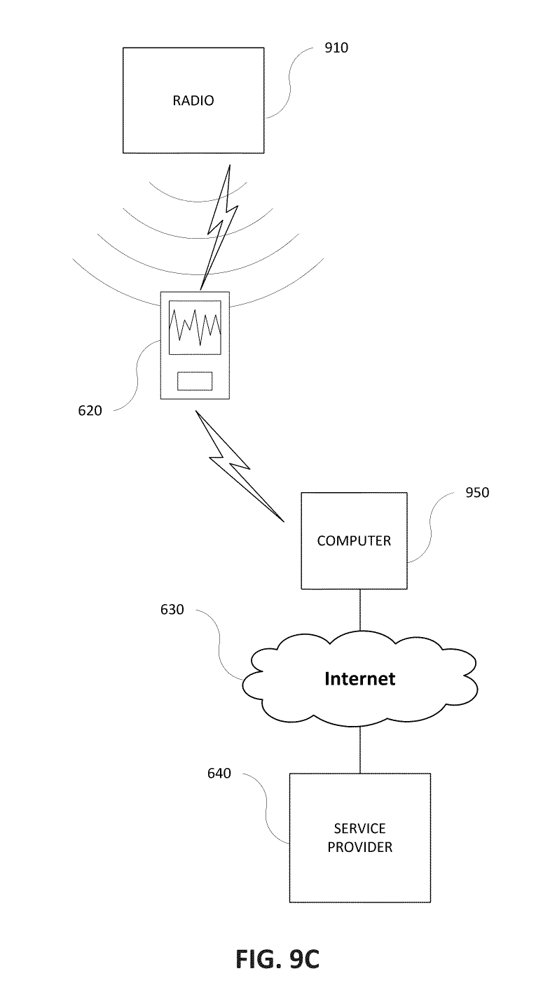

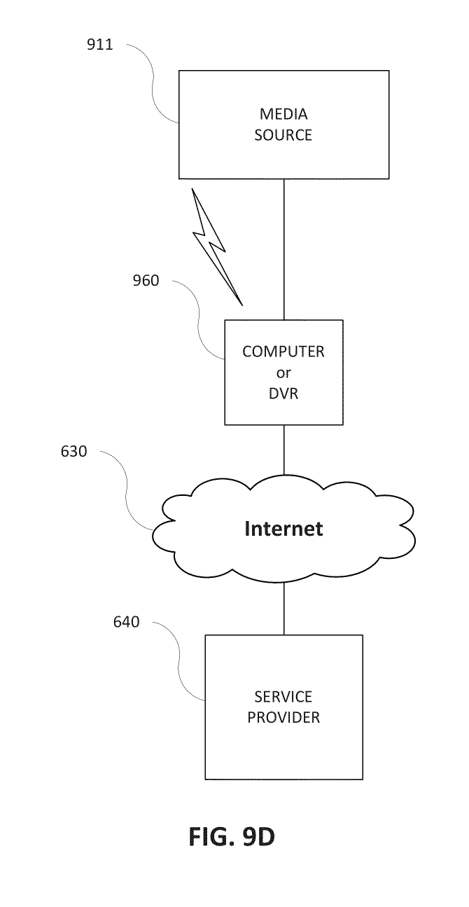

FIGS. 9A-D show some example implementations of device interaction based on media content. FIG. 9A shows that device 620 may communicate directly with media source 610 using any wireless (e.g., infrared, Bluetooth, Wi-Fi, etc.) or wired protocol implemented or supported on both devices.

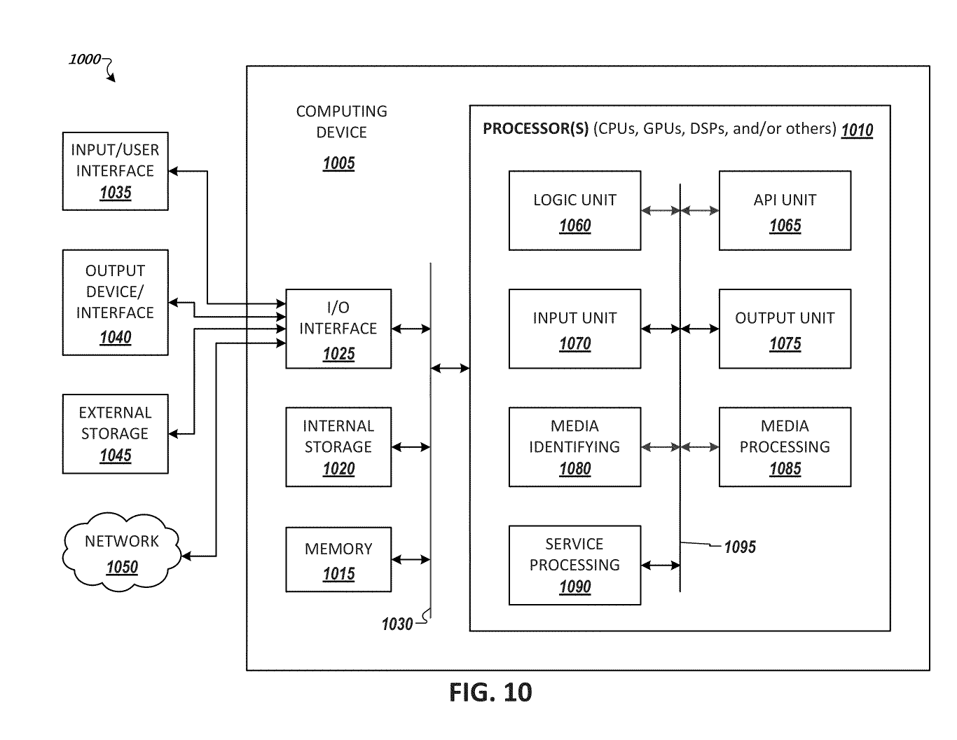

FIG. 9B shows that device 620 may include communication support (e.g., hardware and/or software), such as infrared support 621, Wi-Fi support 622, Bluetooth support 623, and/or other support (not shown). Device 620 may be device 1005 described below (FIG. 10). For example, device 620 may include one or more processors 624, built-in memory 625, and removable memory 626 (e.g., a Flash memory card).

FIG. 9C shows that device 620 may communicate with a computer 950 in some implementations. For example, service provider 640 generates and supplies a pool of Big Fs to computer 950 for matching with the Small Fs sent by device 620. The matching operations performed by service provider 640 described above are performed by computer 950 in this example. This example implementation reduces the frequent usage of the internet 630 and service provider 640. For example, the internet 630 and service provider 640 are used for on-demand and/or periodic updates of the pool of Big Fs on computer 950. Using the provided Big F matrices, computer 950 communicates with and provides content identification information to device 620.

FIG. 9D shows that a computer or digital voice/video recorder (DVR) 960 may be used in some example implementations. In this example, DVR 960 performs the functions of device 620 and computer 950 (FIG. 9C) combined and can be used in place of those devices. For example, media data (audio and/or video data) may be provided to DVR 960 directly via a wire connection or a wireless channel (e.g., Wi-Fi, Bluetooth, etc.). DVR 960 captures the Segment S, generates the Small F, and matches with the pool of Big Fs provided by service provider 640. When an identification of a content (e.g., Segment S) is made, DVR 960 issues one or more commands to media source 911.

Additional Application Examples

The media signatures or fingerprints described above are only examples for identifying media content. Any methods or techniques for identifying an advertisement or content may be employed in place of the described examples. For example, media fingerprints obtained differently from the described examples may be used.

Example Computing Devices and Environments

FIG. 10 shows an example computing environment with an example computing device suitable for implementing at least one example implementation. Computing device 1005 in computing environment 1000 can include one or more processing units, cores, or processors 1010, memory 1015 (e.g., RAM, ROM, and/or the like), internal storage 1020 (e.g., magnetic, optical, solid state storage, and/or organic), and I/O interface 1025, all of which can be coupled on a communication mechanism or bus 1030 for communicating information. Processors 1010 can be general purpose processors (CPUs) and/or special purpose processors (e.g., digital signal processors (DSPs), graphics processing units (GPUs), and others).

In some example implementations, computing environment 1000 may include one or more devices used as analog-to-digital converters, digital-to-analog converters, and/or radio frequency handlers.

Computing device 1005 can be communicatively coupled to input/user interface 1035 and output device/interface 1040. Either one or both of input/user interface 1035 and output device/interface 1040 can be wired or wireless interface and can be detachable. Input/user interface 1035 may include any device, component, sensor, or interface, physical or virtual, that can be used to provide input (e.g., keyboard, a pointing/cursor control, microphone, camera, Braille, motion sensor, optical reader, and/or the like). Output device/interface 1040 may include a display, monitor, printer, speaker, braille, or the like. In some example implementations, input/user interface 1035 and output device/interface 1040 can be embedded with or physically coupled to computing device 1005 (e.g., a mobile computing device with buttons or touch-screen input/user interface and an output or printing display, or a television).

Computing device 1005 can be communicatively coupled to external storage 1045 and network 1050 for communicating with any number of networked components, devices, and systems, including one or more computing devices of the same or different configuration. Computing device 1005 or any connected computing device can be functioning as, providing services of, or referred to as a server, client, thin server, general machine, special-purpose machine, or another label.

I/O interface 1025 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, satellite network, and the like).

Computing device 1005 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 1005 can be used to implement techniques, methods, applications, processes, or computer-executable instructions to implement at least one implementation (e.g., a described implementation). Computer-executable instructions can be retrieved from transitory media, and stored on and retrieved from non-transitory media. The executable instructions can be originated from one or more of any programming, scripting, and machine languages (e.g., C, C++, C#, Java, Visual Basic, Python, Perl, JavaScript, and others).

Processor(s) 1010 can execute under any operating system (OS) (not shown), in a native or virtual environment. To implement a described implementation, one or more applications can be deployed that include logic unit 1060, application programming interface (API) unit 1065, input unit 1070, output unit 1075, media identifying unit 1080, media processing unit 1085, service processing unit 1090, and inter-unit communication mechanism 1095 for the different units to communicate with each other, with the OS, and with other applications (not shown). For example, media identifying unit 1080, media processing unit 1085, and service processing unit 1090 may implement one or more processes shown in FIGS. 2, 7, and 8. The described units and elements can be varied in design, function, configuration, or implementation and are not limited to the descriptions provided.

In some example implementations, when information or an execution instruction is received by API unit 1045, it may be communicated to one or more other units (e.g., logic unit 1060, input unit 1070, output unit 1075, media identifying unit 1080, media processing unit 1085, service processing unit 1090). For example, after input unit 1070 has received or detected a media file (e.g., Segment S), input unit 1070 may use API unit 1065 to communicate the media file to media processing unit 1085. Media processing unit 1085 communicates with media identifying unit 1080 to identify a starting point and a starting matrix. Media processing unit 1085 goes through, for example, process 800 to process Segment S and generate scores for different Big Fs. If a service is identified, service processing unit 1090 communicates and manages the service subscription associated with Segment S.

In some examples, logic unit 1060 may be configured to control the information flow among the units and direct the services provided by API unit 1065, input unit 1070, output unit 1075, media identifying unit 1080, media processing unit 1085, service processing unit 1090 in order to implement an implementation described above. For example, the flow of one or more processes or implementations may be controlled by logic unit 1060 alone or in conjunction with API unit 1065.

Although a few example implementations have been shown and described, these example implementations are provided to convey the subject matter described herein to people who are familiar with this field. It should be understood that the subject matter described herein may be embodied in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A computer-implemented method for processing media data, the method comprising:
receiving a portion of media data;
generating metadata associated with the media data;
identifying another metadata based on the metadata;
identifying content information associated with the another metadata; and
issuing a command based on the content information.

2. The computer-implemented method of claim 1, wherein the generating metadata comprises creating one or more matrices of metadata associated with the received media data.

3. The computer-implemented method of claim 2, wherein the identifying another metadata comprises:
comparing the one or more matrices of metadata associated with the received media data to stored matrices of metadata associated with known media data; and
assigning a score to one or more of the stored matrices of metadata associated with known media data based on similarities determined by the comparison.

4. The computer-implemented method of claim 3, wherein when the assigned score indicates that the one or more matrices of metadata associated with the received media data are similar to the one or more stored matrices of metadata associated with the known media data the received media data are identified as the known media data, and
wherein content information of the known media data is identified as content information of the received media data.

5. The computer-implemented method of claim 1, wherein the command is issued to a media source from which the portion of media data is received.

6. The computer-implemented method of claim 5, wherein the issued command is at least one of a switch channel command, a volume control command, an audio mute command, and a power-off command.

7. The computer-implemented method of claim 5, wherein the issued command is communicated using at least one of a wireless protocol and a wired protocol.

8. A non-transitory computer readable medium having stored therein computer executable instructions for processing media data, the executable instructions comprising:
receiving a portion of media data;
generating metadata associated with the media data;
identifying another metadata based on the metadata;
identifying content information associated with the another metadata; and
issuing a command based on the content information.

9. The non-transitory computer readable medium having stored therein computer executable instructions as defined in claim 8, wherein the generating metadata comprises creating one or more matrices of metadata associated with the received media data.

10. The non-transitory computer readable medium having stored therein computer executable instructions as defined in claim 9, wherein the identifying another metadata comprises:
comparing the one or more matrices of metadata associated with the received media data to stored matrices of metadata associated with known media data; and
assigning a score to one or more of the stored matrices of metadata associated with known media data based on similarities determined by the comparison.

11. The non-transitory computer readable medium having stored therein computer executable instructions as defined in claim 10, wherein when the assigned score indicates that the one or more matrices of metadata associated with the received media data are similar to the one or more stored matrices of metadata associated with the known media data the received media data are identified as the known media data, and
wherein content information of the known media data is identified as content information of the received media data.

12. The non-transitory computer readable medium having stored therein computer executable instructions as defined in claim 8, wherein the command is issued to a media source from which the portion of media data is received.

13. The non-transitory computer readable medium having stored therein computer executable instructions as defined in claim 12, wherein the issued command is at least one of a switch channel command, a volume control command, an audio mute command, and a power-off command.

14. The non-transitory computer readable medium having stored therein computer executable instructions as defined in claim 12, wherein the issued command is communicated using at least one of a wireless protocol and a wired protocol.

15. At least one computing device comprising storage and a processor configured to perform:
receiving a portion of media data;
generating metadata associated with the media data;
identifying another metadata based on the metadata;
identifying content information associated with the another metadata; and
issuing a command based on the content information.

16. The computer-implemented method of claim 15, wherein the generating metadata comprises creating one or more matrices of metadata associated with the received media data; and
wherein the identifying another metadata comprises:
comparing the one or more matrices of metadata associated with the received media data to stored matrices of metadata associated with known media data; and
assigning a score to one or more of the stored matrices of metadata associated with known media data based on similarities determined by the comparison.

17. The computer-implemented method of claim 16, wherein when the assigned score indicates that the one or more matrices of metadata associated with the received media data are similar to the one or more stored matrices of metadata associated with the known media data the received media data are identified as the known media data, and
wherein content information of the known media data is identified as content information of the received media data.

18. The computer-implemented method of claim 15, wherein the command is issued to a media source from which the portion of media data is received.

19. The computer-implemented method of claim 18, wherein the issued command is at least one of a switch channel command, a volume control command, an audio mute command, and a power-off command.

20. The computer-implemented method of claim 18, wherein the issued command is communicated using at least one of a wireless protocol and a wired protocol.
